(19) United States
(12) Patent Application Publication
(10) Pub. No.: US 2014/0278493 A1
(43) Pub. Date: Sep. 18, 2014

(54) Method and System for Determination of Value Units for Use in Physician Compensation Analysis

(71) Applicant: Howard Lieber, Greenwood Village, CO (US)

(72) Inventor: Howard Lieber, Greenwood Village, CO (US)

(21) Appl. No.: 14/207,094

(22) Filed: Mar. 12, 2014

Related U.S. Application Data
(60) Provisional application No. 61/777,783, filed on Mar. 12, 2013.

(51) Int. Cl. G06Q 50/22; G06Q 20/14

(52) U.S. Cl. CPC G06Q 50/22; G06Q 20/14
USPC 705/2

(57) ABSTRACT

This invention relates to a software-based tool for enabling physicians, medical service providers and/or health care providers to accurately track RVUs associated individual service procedures performed during each patient visit/encounter and thereby facilitate recovery of fair reimbursement for such individual procedures. The invention also tracks other data and metrics to further refine the value of the service or procedure performed to further facilitate appropriate reimbursement and compensation.

### CROSS REFERENCE TO RELATED APPLICATIONS

This application claims the benefit of U.S. Provisional Patent Application 61/777,783, entitled “METHOD AND SYSTEM FOR DETERMINATION OF VALUE UNITS IN PHYSICIAN COMPENSATION ANALYSIS” filed on Mar. 12, 2013, the entire contents of which are incorporated herein by reference in its entirety for all purposes.

### FIELD OF THE INVENTION

This invention relates to a software-based tool for enabling physicians, medical service providers and/or health care providers to accurately track RVUs associated individual service procedures performed during each patient visit/encounter and thereby facilitate recovery of fair reimbursement for such procedures. The invention also tracks other data and metrics to further refine the value of the service or procedure performed to further facilitate appropriate reimbursement and compensation.

### BACKGROUND OF THE INVENTION

It is believed that physicians and other medical service providers presently rely either upon crude estimates of the number of patient encounters or a software application iRVU. iRVU calculates an estimate of ‘total’ RVU (and associated total charges) based on a total number of encounters per coding level entered manually by the provider. It does not allow for tracking patient information and/or RVUs associated with individual encounters. Thus, the provider may be in a weak evidentiary position for disputing fees calculated by insurers and hospitals which may be considered less than fair compensation. RVUs undergo annual updates and each iteration of the RVU formula has direct implications for physician reimbursement. This value is based on the RBRVS. RVU represents the skill level, time and effort, and malpractice risk necessary for a procedure and is geographically weighted. A low RVU indicates a low complexity procedure, whereas a high RV indicates a high complexity procedure.

Current applications are insufficient in compiling data that can be used effectively by stakeholders in the health care industry. While healthcare reform remains an important and timely topic for political and economic debate, the parties are in agreement that the efficient and effective use of health care resources and the delivery of services are critical to long term success. The majority of health care service providers, however, have very little understanding as to how physician reimbursements are calculated and modified, as medical practice trends and supporting technologies rapidly evolve.

Certain concepts, such as Pay for Performance and Evidence-Based Medicine include data standardization and accessibility. These concepts use financial incentives tied to quality improvement. However, an argument can be made that the current reimbursement does not go far enough. Particularly, deficiencies exist related to transparency, accountability, accessibility, and quality. Of particular concern are those who are most affected by such concepts, physicians and health care providers, often do not have access to information used in making determinations according to the process or an easy way to assess how such concepts are applied. Therefore, it is critical for a physician or health care provider to have access to information and how it can help modify and refine the existing reimbursement model to reflect these principles in order to achieve parity in bargaining positions when determining the proper compensation for work performed.

It is known in the art that physicians can input data over the internet through online subscription services where the data is electronically to be stored into a database. For example, U.S. Pat. No. 8,185,409 issued to Putnam et al. (“Putnam”) describes a method and apparatus that allow a plurality of physicians to enter data into an event database. Putnam is incorporated by reference in its entirety. According to Putnam, the physicians input the data through an interface that assists in coding the event using a Wide Area Network, or, “WAN.” Putnam focuses on streamlining the documentation provided by a physician by using the input from the physician and associating the data with a code for the event, such as a CPT code, linking the CPT code to an ICD code, and improving storage, ownership and control of the data, such as EMR.

Furthermore, it is known that certain information can be inputted into a system and provide information regarding treatment of a patient. For example, U.S. Pat. No. 8,170,888 issued to Silverman (“Silverman”) describes a multi-dimensional system for assessing, coding, quantifying, displaying, integrating and communicating information related to patient health. Silverman is incorporated by reference in its entirety. Silverman accounts for information such as patient health, preoperative risk, expected surgical risk and invasiveness, vital assessments for perioperative complexity and provides alphanumeric codes and scores to help determine if certain special preoperative preparation and planning is needed.

It is known that certain data, particularly medical data can be used in determining a value associated with the type of work or service performed. After all, the RVU uses particular sets of data to provide an estimated and standardized number to a service performed. It is also known that a different Value Unit may be calculated using different types of data for specific purposes.

For example, U.S. Pat. No. 5,918,208 issued to Javit (“Javit”) describes a system and method for comparing venues and costs generated under at-risk contracts with those generated under traditional fee-for-services agreements. Javit is incorporated by reference in its entirety. Javit describes a graphical, interactive computer system that uses user input relating to alternative contract scenarios to consult a database for national and locality specific utilization data, analyzes utilization and revenue data for both commercial and Medicare-age beneficiaries, provides a synthetic fee schedule for comparing the likely revenue and costs under capitation for multiple services to revenue under a current reimbursement scenario and enables a physician to use a broad array of assumptions to forecast utilization of medical procedures and estimated revenue per procedure under multiple capitation scenarios.

U.S. Pat. No. 8,249,892, issued to Reiner (“Reiner”), describes a method of creating a database for data mining in medical applications. Reiner is incorporated herein in its entirety. Reiner describes using items tied to patient, exam, context and other provider-specific variables to assist in providing an objective reimbursement model for radiologists. According to Reiner, additional data, such as imaging quality and type of technology available and used particular to radiologists may not be accounted for in an RVU directed towards a different specialty. For example, imaging techniques and protocols for the same imaging examination may vary between institutions. One institution may require a 4 detector CT scanner and imaged in the axial plane only, without reconstructions. The second institution acquires the image on a 64 detector CT and performs multi-planar reconstructions. Although the examination is performed on the same patient for the same clinical indication, the complexity and times would be different. Thus, Reiner addresses adding additional data to a radiologists' reimbursement model to address variations in patient, institutional protocols, technology, imaging, and exam profiles. The present invention is more expansive than the prior art, as it allows further customizability as well

It is also known that hospitals and health care facilities determine reimbursement for their physicians or health care providers on certain performance metrics. For example, U.S. Pat. No. 7,996,241, issued to Zak et al., (“Zak”), describes a method and system for reimbursing health care providers through an integrated management system. Zak is incorporated herein in its entirety. According to Zak, the method and system addresses the above stated need for rewarding health care providers in a health care organization based on performance of the health care providers. The method and system provides a web application for analyzing performance of the health care providers. The health care providers include primary care physicians, procedurally related group specialists, medically related groups specialists, provider networks, hospitals, and ancillary providers. The web application acquires information from multiple medical management systems. The medical management systems include a utilization analytics system, provider profiling system, an intelligent health care quality improvement system, a disease and case based management system, referrals and authorizations management system, and a health risk assessment system. The acquired information includes intelligent health care quality improvement analysis information, disease and case based management information, utilization analytics information, physician profiling information, authorizations management information, lab and imaging information, and health risk assessment information. The acquired information further includes information of members enrolled with the health care providers. The information of the members includes information of health plan benefits, medical claims, pharmacy claims, hospital information, allied health centers information, authorizations and referrals information, lab and imaging information, disease conditions, and comorbid conditions of the members. Further, the web application determines performance indices for the health care providers based on the acquired information. The web application analyzes the performance of the health care providers based on the determined performance indices. The performance analysis also includes identifying health care providers eligible for a reward. Further, the method and system disclosed rewards the identified health care providers based on the analyzed performance. The web application enables the health care providers to update unobserved performed health care measures. The web application monitors the performance of the health care providers and further identifies ineffective health care providers. The ineffective health care providers are provided recommendations for improvement on health care management in order to improve the performance. By monitoring and analyzing the performance of the health care providers, the health care organization reduces medical costs and increases quality of care to the enrolled members. According to Zak, health care administrators and medical directors configure pay performance to assign a predetermined weighted percentage value for each of the performance indices and adjusts compensation accordingly. Although Zak describes a system and method to be used by health care administrators and medical directors to compensate physicians and health care providers, Zak does not teach or suggest a system and method where physicians and health care providers have similar access to the information used in determining compensation such that there is parity in bargaining positions.

By way of providing additional background, context, and to further satisfy the written description requirements of 35 U.S.C. §112, the following references are incorporated by reference in their entireties for the express purpose of explaining the nature of the health care industry and methods to further describe the various systems, sub-systems, tools and components commonly associated therewith: U.S. Pat. No. 5,918,208 issued to Javitt, U.S. Pat. No. 7,552,063, issued to McEachern, U.S. Patent Application Publication No. US 2009-0222284A1 by McEachern, U.S. Patent Application Publication No. US 2012/0290314A1 by Putnam et al.; U.S. Patent Publication No. US 2006/0074712A1 by Jorgensen et al.; U.S. Patent Application Publication No. US 2008/0262882A1 by Farrell, U.S. Patent Application Publication No. US 2012/0296675AT by Silverman; U.S. Patent Application Publication No. US 2009/0144113A1 by Hamilton et al.; U.S. Patent Application Publication No. US 2002/0111826A1 by Potter et al., U.S. Patent Application Publication No. US 2001/0041990A1 by Javitt; PCT Publication No. WO2010/030530 by Campo et al.

### SUMMARY OF THE INVENTION

Embodiments of the present invention are directed at providing a physician or health care provider with a simple and quick way to verify compensation structures that factor in RVUs. In certain embodiments, the standardized billing codes associated with the description and the corresponding RVU are correlated and selected. Having the particular standardized items correlated to each other provides accuracy to determine the values associated with the service or procedure performed. Furthermore, embodiments of the invention allow the physician or health care provider to customize the data provided in determining the values that should be associated with the services or procedures performed by allowing the physician or health care provider to provide additional data, such as how long the procedure took, along with specific notes associated with the entry. Other data sets and metrics may also be used for further customizability and accuracy.

The terms “physician” or “doctor” has its generally known meaning The term “health care provider” can also include physicians and doctors, as well as a physician's assistant, registered nurse, nurse practitioner or other person that provides health care related services for a patient and has patient contact. Any person who is practicing the invention may be considered a “user,” including health care administrators.

The term “RBRVS” means Resource Based Relative Value Scale, which is a schema created by Harvard University used to determine financial compensation for medical services. RBRVS assigns procedures performed by a physician or other health care provider a relative value which is adjusted by geographic region. This value is then multiplied by a fixed conversion factor, which changes annually, to determine the amount of payment.

The term “RVU” means Relative Value Units as assigned by Medicare and/or Medicaid as the number value associated with at typical billing unit. An RVU is a measure of value used by insurance companies and assigns the complexity of a provided service used to calculate reimbursement of physician services.

The term “CPT Code” means a set of health care procedure codes based on the American Medical Association's Current Procedural Terminology (“CPT”) standardized coding system for describing the specific items and services provided in the delivery of health care. Each CPT code has a predefined RVU.1

The term “Value Unit” refers to the number generated through certain datasets as inputted and selected by the user.

The term “EMR” means electronic medical records. The term “HIPAA” refers to the Health Insurance Privacy and Accountability Act.

Embodiments of the present invention allow the physician or health care provider quick access to determine certain data sets or metrics by being able to sort the inputted information by data type. For example, data can be aggregated by code in order for a quick view for a physician or health care provider to determine and compare how often he or she performed a certain type of service or procedure. This data set could also include the amount of time that a physician or CPT is a registered trademark of the American Medical Association health care provider spent on that particular service or procedure. In addition, this data set could also be correlated by the age of patient and notes to determine the amount of time it took and provide insight into the variability between the procedures. In turn, being able to quickly compare these data sets provides insight into variability of procedure times and why certain procedures may have taken longer in certain situations. Moreover, by having this dataset, the physician or health care provider would be informed as to his or her overall efficiency and the accuracy of providing a correlating RVU. As the RVU is an attempt to standardize the value associated with a procedure, having quick access to data as provided by embodiments of the present invention allow a physician or health care provider to determine the accuracy of the RVU as related to the services performed by the individual physician or health care provider. This would thus allow the physician or health care provider to engage in an informed negotiation during performance reviews or compensation reviews.

By providing a simple correlation with this particular data, in addition to the standard RVU related to a certain code assigned to a procedure, certain embodiments allow additional data to be used in order to determine different metrics specific to a physician or health care provider. For example, imagine a patient presents with a particular complaint that requires a physician to perform a relatively straight-forward procedure. However, for a certain demographic, certain conditions, such as high cholesterol, may be known to be more prevalent. As a result, the physician may have to take more prophylactic measures or perform a more detailed evaluation due to the complications that may arise because of high cholesterol. This type of knowledge adds to the value of the procedure or service performed and may not be accounted for in standardized metrics such as RVUs and thus adds to the complexity of the procedure. Thus, even though the time may have taken a longer for a particular patient, the result and ability to better treat or further avoid complications due to the doctor's knowledge and skill. This type of knowledge would thus assist in achieving better compensation as it “tells the whole story” in determining the value provided by a physician or a health care provider.

Other embodiments address the problems associated with current practices. With the above stated continuing efforts to reduce medical reimbursements, many physicians or health care providers have reacted by increasing productivity, in order to maintain revenue. This continuing push to increase speed carries the risk of diminished quality, in the form of diagnostic accuracy. Thus, synergistically improving both productivity and quality, through the combined analysis of examination complexity, interpretation accuracy, and interpretation times, specific to each individual physician or health care provider is needed. Improvements can be fostered by using additional data and metrics that can be used and aggregated to increase transparency and availability. In turn, there can be an enhancement in performance, education, and informed decision making

The present invention makes recommendations for creation of a data-driven objective reimbursement model incorporating performance and quality measures, tied to patient, exam, context, and provider-specific variables. Aspects are directed at reducing the impact of politics and professional societal influence, creating an objective series of standardized metrics to use in reimbursement calculations, making all data readily accessible to interested parties, along with the methodology used to establish reimbursements, transitioning from a reimbursement model of effort to one of combined effort and effect, and incorporating data reflecting quality, clinical outcomes, and technology.

Other aspects involve productivity/workflow analysis and performance enhancement. Data-driven pacing offers the potential to improve productivity, workflow, and diagnostic accuracy. This can be accomplished by the program recording context and user-specific data within a longitudinal and iterative database, which can be analyzed to determine exam complexity and estimated task completion times. By developing functional components adaptable to the specific needs and preferences of each individual end-user, the program is customizable and adaptive to each individual practitioner. Goals of the present invention are to enhance productivity and workflow, improve diagnostic accuracy, provide customized education, and reduce cumulative fatigue through creative data mining and analysis. In another embodiment consistent with the present invention, medical data mining offers the potential to enhance workflow and diagnostic accuracy through objective data-driven analytics, which can be categorized in accordance with specific variables relating to the individual exam, patient, provider, and technology being utilized.

Certain embodiments allow a user to select which data sets may be used in determining a particular value output. Allowing data sets to be customized to a particular field or specialty is especially beneficial as not all data may be relevant in determining value for services provided. Although there is a broad sub-categorization in place, certain embodiments of the present invention allow for further customizability. For example, although the same procedure may have a different RVU assigned due to practice area, e.g., the RVU associated for a patient visit for a cardiologist may be different than an RVU associated for a visit for a neurologist, certain embodiments of the present invention help further refine data and thus provide a more accurate dataset. As one can imagine, performing the same procedure on different patients cannot always be standardized. For example, different precautions may need to be taken and procedures performed differently for a pediatric patient and a geriatric patient. Indeed, subspecialties within specialties are further becoming more and more focused on very specific areas of practice. This is recognized as RVUs are reviewed periodically in order to update an assigned value as necessary. Thus, as practices and specialties evolve even more quickly, broadly assigned RVU no longer can encompass accurate measures of value provided by a physician or health care provider. The present invention addresses the need to create a real-time and more accurate determination of value.

Embodiments allow data sources to be customized by the user. The data sources can be selected for comparison purposes and/or as a data set to be used in a calculation of a Value Unit. Data sources include CPT codes, geographic practice cost index (“GPCI”), Health Care Common Procedure Coding System (“HCPCS”), National Correct Coding Initiative (“NCCI”), Local and Medical Review Policy data (“LMRP”), in addition to RVUs. The data may also be selected for informational purposes, such as comparing the different values or numbers assigned to each procedure by each particular indicia. Certain aspects of the present invention is directed to providing a physician or a health care provider (or other interested parties) with the most relevant information in order to assist in a physician or health care provider in receiving proper compensation by providing quick and easy access to information that is often used in the negotiation process. Providing multiple sets of data such as those described for comparison purposes or to help calculate a more accurate value.

Embodiments of the present invention include storing, correlating, and the ability to select information that is most pertinent to a particular practice specialty. For example, information regarding procedures performed in oncology is provided and correlated to the relating billing code and/or procedure code, as well as the RVU associated with the procedure. Information specific to the procedures performed by specialty also include cardiology, OBGYN, orthopedics, pain management, pediatrics, family medicine, internal medicine, urology, ear nose throat, ophthalmology, general surgery, bariatric, radiology, and dentistry. Certain embodiments allow the comparison of the information regarding the procedures and the associated RVU or Value Unit to help further analyze the particular physician or health care provider's performance and compensation in relation to other specialties. Certain procedures or services may have different RVUs or Value Units assigned to the same procedure or service, based on the assumption that the procedure or service is more difficult for one particular specialty and not the other. Providing cross-sectional information along with the additional data specific to the type of service or procedure can assist in determining whether an RVU or Value Unit is under or over- valued.

In yet other embodiments, the “traditional” value can be compared to a more accurate value that takes into account more refined metrics and datasets. This comparison is made readily available through an interface of the present invention, and allows a physician or health care provider to compare how his or her compensation should be increased due to factors not previously considered by using the traditional calculation with a broadly based RVU as the dataset in determining compensation. Certain embodiments allow a user to import the data provided and compare the data through the use of the present invention. This data could be imported wirelessly, through technologies known to those in the art, such as Bluetooth connectivity, peer-to-peer, email, cloud sharing, etc. Embodiments can compare data and results for RVUs with hospital systems currently used by those hospital systems. This can include a display that provides the different types of data and other metrics that are used to determine the comparison Value Unit so that both parties are informed as to why a certain Value Unit was calculated or associated with a procedure and why it may vary from the standard RVU assigned to that procedure.

As both parties will appreciate, being able to compare data sets and the information used in determining the value provided by a physician or health care provider would be beneficial to the negotiation process. Allowing an informed negotiation on behalf of both parties would take the disingenuoity out of the negotiations and allow the parties to negotiate based on a physician or health care provider's actual performance as opposed to a disparity in information available. Embodiments of the present invention are directed towards the easy import and comparison of data available to both parties.

Other embodiments of the present invention allow a physician or a health care provider to compare his or her performance with others. This can be a comparison to other physicians or health care providers within the department, within the region, within the nation, internationally, etc. Embodiments allow the comparison to be displayed in a plurality of ways, such as a textual description or a graphical depiction, including bar graphs, pie graphs or others.

Yet other embodiments of the present invention include a simplified interface for quick access to the most relevant data. Certain compensation determinations may be based on the premise that a physician or health care provider may not have access even to the simplest information regarding the amount of work performed. In such situations, embodiments of the present invention are directed to ease and quick access to provide a physician or health care provider basic and the most relevant information regarding the work performed. Such embodiments can be beneficial in situations where one only needs the most relevant data, and other items that may further complicate negotiations are not needed. That is, if physician compensation and negotiations revolve around certain core data, embodiments of the present invention allow a user to eliminate what is not necessary and focus on the data most relevant to negotiations and the determination of compensation in more straight-forward and less complex negotiations processes.

Other embodiments of the present invention allow data to be integrated with different insurers. Data from insurers can comprise data related to payment for the particular service or procedure performed by the physician or health care provider. Such data could be factored into the type of procedure or service performed, compared to data regarding standard RVU determination, analyzed in light additional information specific to each entry, and thus calculating appropriate compensation.

Certain embodiments of the present invention are integrated with all insurance companies and payors. Insurance companies include Medicare, Medicaid, United Health, Blue Cross Blue Shield, Aetna, Cigna, Humana, PacifiCare, and Golden Rule. Integration with insurance companies allows access to certain information including the amount charged for the procedure, the rate of reimbursement, the actual reimbursement, etc. Moreover, integration with all insurance companies and payors can provide a cross-sectional analysis as to reimbursement rates throughout the industry. Such integration allows the physician or health care provider more access to information that is often used in determining a RVU or Value Unit. With this type of information, a physician or a health care provider can be further informed as to his or her productivity and provides a bargaining tool. As those skilled in the art can appreciate, certain embodiments can adapted by insurance companies to use such integration with all insurance companies to provide information and metrics that can help refine an insurance plan and/or policy and reimbursement rates.

One aspect of the present invention relates to the efficient accumulation and tracking of information by a medical professional so as to more accurately conduct audits and future economic ramifications of compensation to medical professionals by other entities, including hospitals, prepaid medical services, Medicare, Medicaid, etc. In the various methods and systems set forth herein, many of the same may employ the use of bar coded information, QR coded information or other types of electronically and digitally encoded information, that can be scanned by handheld or other conventional types of scanner technologies, including hand held smart phones, etc. In particular, bar coded information concerning a patient's identity, current residence, status, drug regimen, various HIPAA regulations and concerns, referring physicians, fast physicians, former medical procedures, etc. can be scanned into an information data storage file in order to have such information available for later use. In addition to patient related information, information may also include various information concerning the attending physician or medical staff, including skill level, prior misconduct, restricted areas of practice with respect to surgeries, limitations with respect to pharmaceutical distribution and/or prescriptive abilities, various ratings by independent third party agencies, such as an AVVO rating of the physician and/or the hospital and/or service; hospital data with respect to costs of procedures being performed, either regionally, in the past and/or on a collective basis, etc. Again, such information can be encoded, such as a bar coding QR coding, or other digital readable means, such that such information can be readily accessed and downloaded into various files so that such information can be combined, contrasted and compared with other information in order to conduct a thorough cost analysis and allocation in order to develop appropriate fee schedules for prospective medical procedures and care for patients and patient populations.

In one particular aspect of various embodiments of the present invention, it may be important to determine how the particular procedure at issue may be compensated in various areas of the country, if not internationally. For example, a similar knee replacement procedure performed in the Boston metro area may be far different than the same procedure performed in the Denver medical marketplace. By having such information available for an efficient and readily available comparison analysis, administrators of medical services and disbursement of costs associated therewith can more carefully gauge how particular patient procedures should be employed, including, for example, where such procedures should be conducted. In such a manner, not only does the hospital, physician and patient can be informed of such information, but the ability of the patient, hospital and physician to potentially change the location of a particular procedure can be arrived at. For example, with respect to the above-referenced scenario, it may be advantageous for the patient, who may have relatives and/or a support network in Denver to travel from their home in Boston to Denver for a particular medical procedure. The ability to offer a patient such an alternative would necessarily effect the bargaining position of the hospital and/or the physicians involved in determining a fair and appropriate compensation model for similar services throughout the nation.

In a similar vein, other parameters may be recorded into a database for analysis of how best to facilitate the most cost effective and practical provision of medical services. For example, it may be that certain curative practices may not require expensive and specialized surgical operations, but rather, such physical ailments can be better addressed through a physical therapy regimen that may ultimately be more beneficial to the patient from a pain perspective, cost perspective and long term prognosis perspective. Providing the option to both a patient, physician and hospital to consider the relative and up to date data of success with respect to physical therapy versus various surgical procedures, can readily and immediately inform the parties making such patient care decisions as to the most pragmatic and cost effective available options.

On a smaller scale, comparisons within a particular region where the patient may reside can be employed in order to compare and contrast various physician rates, levels of experience, potential malpractice allegations and/or assertions, costs and attributes of various care facilities for performing the necessary medical care delivery as well as follow up procedures, etc., such that the costs and efficiency of an entire care program may be facilitated. Thus, instead of merely relying upon agency and/or statutory codes with respect to reimbursement of particular procedures, combinations of procedures, etc., the interested individuals in making the patient care decisions can be more fully informed as to a wide variety of economic, practical and medical industry standard data points and considerations. The overall employment of various embodiments of the present system and method involves a streamlined, efficient and cost effective way to evaluate disparate, but yet relevant information in a fashion so that individual administrators, physicians and patients can access such information on their mobile smart phone, iPad or other similar type devices.

Other embodiments include information regarding different international practice locales, types of procedures performed in other locations, and the ability to perform certain procedures in different locales. This information may be used to determine the Value Unit and provide a physician or health care provider with additional information regarding patient care. For example, certain patients may elect to have certain procedures performed in different areas due to treatments being available in certain areas and unavailable in others. Certain international areas may have fewer administrative hoops or less red tape to allow treatments, whether such roadblocks to access are technical or political. For example, certain people may chose to receive treatment in Singapore or Europe where certain procedures or treatments, although safe, are not allowed in the United States because of the use of certain types of stem cells. Furthermore, there are some procedures and/or treatments that may be safely performed but are not performed because, although the procedure, treatment, product, and or device is safe and has obtained the necessary clearance for one use, it is has not received the necessary clearance for another use. Data regarding these types of treatments and/or procedures their complexity, and the difficulty of an alternative procedure in the United States can be used and beneficial and is often ignored in determining that compensation rates. Stated another way, there may be a simpler, more effective, and less costly course of treatment that is unavailable in a particular locale. This factors into how a physician or health care provider should be compensated for undertaking a more complex treatment or procedure.

And, as these procedures and/or treatments have not received administrative approval within the United States, insurance companies will not reimburse for these items. A physician or health care provider could thus use the present invention in determining whether it is more economical to obtain hospital privileges elsewhere, where patients are willing to pay out of pocket. Embodiments account for such variations and can provide information and data to the physician or health care provider through the network and on the communication device.

In yet another embodiment, EMR software programs are integrated. In certain embodiments, the integration of EMR software programs allows the present invention to download information that originated from the EMR software program. Certain embodiments may also include the ability to edit and interact with the EMR software programs where the EMRs can be edited by the present invention to allow real-time edits to the EMR. Other embodiments provide synchronization with the EMR software programs where edits made the present invention synchronize with the EMR software to update the EMR with those edits. Integration with EMR software can be with the practice management aspect. Integration and access to EMR data can also be used as a data point in determining a Value Unit for a service or a procedure performed. Examples of EMR software programs that can be integrated include Greenway, Eclinical Works, Next Gen, Epic, and Centricity.

As those skilled in the art can appreciate, the present invention meets HIPAA standards as there is a unique identifier for the encryption key that allows the user to interact through the network. Moreover, the present invention can be practiced without much change to the policies already in place regarding protected health information (“PHI”). A standard HIPAA release already in use by physicians, health care providers, and health care facilities do not require much modification if any, as the present invention uses the required encryption process and unique identifiers to the login credentials as approved to be HIPAA compliant. Still, other embodiments of the present invention allow removal of any personal identifiers so the information would not be considered PHI pursuant to HIPAA. Certain embodiments, although still containing the requisite protections and encryptions in place to be HIPAA compliant can remove the personal identifying data from a patient record for further privacy protection while still maintaining the requisite data that can be used in refining metrics and Value Units. Other embodiments comprise displaying PHI and/or other information that are potentially subject to HIPAA regulations in a manner that distinguishes the information from non-protected and/or non-regulated information. The display may be a different color font, underlined font, or any other way where a user can differentiate that certain information is displayed differently from other information. The display may be customized by the user. For example, a user may select to display PHI in red font, where non-PHI is displayed in black font.

In certain embodiments of the invention, the physician or health care provider inputs information related to a patient visit on a tablet device through an application. This embodiment comprises, a user selecting the application on the tablet device, inputting the user's login credentials; selecting a patient for whom the user will input information; inputting the information about the patient; choosing a the type of service or procedure performed; recording the amount of time spent on the procedure; associating a Value Unit with the type of procedure; confirming the information entered by the user; storing the information on a database; comparing Value Units with proposed Value Units; and determining a compensation rate from Value Units.

Other embodiments of the present invention do not require a software download or to be stored on the user device, e.g., the application that is completely online or in the cloud. A physician or a health care provider would not have to install specific software onto a user device. Rather, a physician or health care provider (or other user) would access the application through a portal. The portal can be through a website portal, internet portal, intranet portal, Virtual Private Network (VPN) or any other way to interact through a network. As those skilled in the art can appreciate, use of a cloud-based network would allow access from almost any access point that can interact or communicate with a network.

Preferred embodiments of the present invention are directed towards physicians and health care providers. However, as those skilled in the art can appreciate, the present invention is not so limited, and other embodiments include the use of the present invention can be practiced for all employees or by hospitals or other users. Moreover, although preferred embodiments are directed to accurate determination of physician or health care provider compensation, other embodiments that function to include payroll are within the scope and spirit of the present invention.

The term “user interface” and/or “UI” refers to any means by which a user and a device, machine, or a computer system interact, including the use of hardware, input devices, UI devices, and software. A user interface provides a means of input, allowing the user to manipulate a system, and/or output, and allowing the system to indicate the effects of the users' manipulation. The terms “application user interface data” and “application UI data” refer to any data typically sent from an application to the user interface on a device or data sent from an application programming interface (“API”). The application UI data may be sent from any database, API, or other medium capable of sending application UI data, including but not limited to the following: an API, a database connected through an API, a database in the application, a database in a different application, a database on the device, a database on an external server, a database on an external device, a database on a network, or any other database, module, or other medium with which the application is in communication

The terms “user interface device” or “UI device” refer to any selectable or non-selectable characters associated with the operation of the UI. A user interface device also includes any graphical representation of application data displayed to a user on a user interface.

The term “computer-readable medium” refers to any tangible storage that participates in providing instructions to a processor for execution. Such a medium may take many forms. Common forms of computer-readable media include, for example, a floppy disk, a flexible disk, hard disk, magnetic tape, or any other magnetic medium, magneto-optical medium, a CD-ROM, any other optical medium, NVRAM punch cards, paper tape, any other physical medium with patterns of holes, a RAM, a PROM, and EPROM, a FLASH-EPROM, a solid state medium like a memory card, any other memory chip or cartridge, or any other medium from which a computer can read.

The term “communication device” refers to any hardware device and/or software operable to engage in a communication session. For example, a communication device can be an IP-enabled phone, a desktop phone, a cellular phone, a personal digital assistant, a soft-client telephone program executing on a computer system, etc. A communication device includes devices using the iOS platform (e.g. iPhones and/or iPads), Mac OS, Windows platform (desktop and/or mobile), Google Android/Chrome OS, BlackBerry OS, Java, Unisis, UNIX, and/or other platforms known in the art.

The term “network” as used herein refers to a system used by a communication platform to provide communications between communication endpoints. The network can consist of one or more session managers, feature servers, communication endpoints, etc. that allow communications, whether voice or data, between two users. Generally, a network can be a local area network (LAN), a wide area network (WAN), a wireless LAN, a wireless WAN, the Internet, etc. that receives and transmits messages or data between devices to facilitate communication platform activities. A network may communicate in any format or protocol known in the art, such as, transmission control protocol/internet protocol (TCP/IP), 802.11g, 802.11n, Bluetooth, or other formats or protocols.

The term “database,” “archive,” or “data structure” as used herein refers to any system, hardware, software, memory, storage device, firmware, component, etc., that stores data. A database can include one or more data structures, which may comprise one or more sections or portions that store an item of data. A section may include, depending on the type of data structure, an attribute of an object, a data field, or other types of sections included in one or more types of data structures. The data structure can represent a text string or be a component of any type of database, for example, relational databases, flat file databases, object-oriented databases, or other types of databases. Further, the data structures can be stored in memory or memory structures that may be used in either run-time applications or in initializing a communication.

The terms “determine”, “calculate” and “compute,” and variations thereof, as used herein, are used interchangeably and include any type of methodology, process, mathematical operation or technique.

While various embodiments the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

### BRIEF DESCRIPTION OF THE DRAWINGS

FIG. 1 depicts certain embodiments of a system of the invention.

FIG. 2 depicts a block diagram of certain embodiments of the invention and the administrative interface.

FIG. 3 depicts a block diagram with an expanded view of certain data that can be selected.

The accompanying drawings, which are incorporated in and constitute a part of the specification, illustrate embodiments of the invention and, together with the general description of the invention given above and the detailed description of the drawings given below, serve to explain the principals of this invention.

It should be understood that in certain instances, details that are not necessary for an understanding of the disclosure or that render other details difficult to perceive may have been omitted. Further, the drawings of the system and/or method do not detail all features of the system and/or method, and do not show the entire system and/or method. It should be understood, of course, that the disclosure is not necessarily limited to the particular embodiments illustrated herein.

### DETAILED DESCRIPTION OF VARIOUS EMBODIMENTS OF THE INVENTION

FIG. 1 depicts certain embodiments of the invention. Element 1050, Enter Store Data, comprises a UI where a user interacts with the invention where the user may enter certain information, such as patient identification, insurance, payers, hospitals, insurers. Element 1100, Table, provides information regarding a procedure. This information can include a code associated with the particular procedure. The code can include standard codes used in the industry, such as ICD codes, insurance billing codes, etc. Element 1100 also includes information of a Value Unit associated with a particular procedure. Certain embodiments use RVUs as generally used in the industry. Other embodiments may include other Value Units associated with the procedure that account for additional information and data. Certain embodiments include RVUs that are automatically associated with the particular procedure, where the RVU associated with the procedure is static and cannot be changed. Other embodiments include a comparison of an RVU as used typically used in the industry with a Value Unit that can be more refined for accuracy by using data inputted by the user. Element 1150, Custom Report Generator, provides information regarding relevant codes and/or Value Units associated with the procedure. This information can be customized and sorted, where the output to the user is aggregated by code, type of procedure, RVU and/or Value Unit. This allows the user access the most relevant information. For example, if the user wants to know how many times he or she performed a certain procedure, the user can sort by code for that procedure or by the description of the procedure. Likewise, if the most pertinent information to the user is the value of RVU or Value Unit, Element 1150 can provide a custom view that enables user to see which procedures performed had the highest and/or lowest RVU associated with it and how many times the procedure was performed.

FIG. 2 depicts a block diagram of the administrative interface of certain embodiments of the invention. As seen in FIG. 2, certain embodiments include interacting with the invention through a network and accessing the network through a portal such as a website or through an application or app on a smart device, Element 2100. A user logs in, as depicted by Element 2150, where credentials are confirmed, Element 2200. Element 2050 depicts a database where information is stored and interacts with the communication device through a network. Element 2050 can store information including List of Patients, Element 2250; List of Users, Element 2300; and Reports, Element 2400. In certain embodiments, Element 2400 can provide certain information to the user arranged according to certain parameters selected by the user. For example, output to a user may be aggregated by total Value Unit Per Physician, Element 2410; Total Value Unit Per Department, Element 2420; Total Value Unit per Code, Element 2430; Total Value Unit Per Patient, Element 2440; Total Value Unit During Period Of Time, Element 2450.

FIG. 3 depicts a block diagram with an expanded view of certain data that may be entered and/or selected by a user according to certain embodiments of the invention. Element 3100 depicts the communication device. Element 3200 depicts data that can be entered or selected for a patient. Element 3200 comprises Patient Information, including vital signs, data of birth, etc., Element 3210; Known Risk Factors, Element 3220; Patient Medical History, Element 3230; SOAP Notes, Element 3240. Element 3300 depicts data that can be entered or selected for a procedure or service. Element 3300 comprises Element 3310 RVBS; Element 3320 HCPS; Element 3330 CPT; Element 3340 RVU; Element 3350 NCCI; Element 3360 CMRP; Element 3370 ICD; Element 3380 GCPI. Element 3400 depicts other data that can be selected or entered regarding the procedure or service. Element 3400 comprises Regional Geographic Data, Element 3410; International Geographic Data, Element 3420; Local Geographic Data, Element 3430; National Geographic Data, Element 3440; Insurance Data, Element 3450.

The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the exemplary claim provided herein.

What is claimed is:

1. (canceled)

2. (canceled)

3. (canceled)

4. (canceled)

5. (canceled)

6. (canceled)

7. The method of claim 2 wherein the Value Unit is automatically associated with the type of procedure performed.

8. (canceled)

9. (canceled)

10. (canceled)

11. A system to determine an accurate value for the health care procedure or service performed to assist a physician or health care provider in determining appropriate compensation comprising:
a. a communication device on which an application is stored;
b. a user interface where a user can input information, including said user's login credentials, notes about a patient, a service or procedure performed by said user, time spent by said user on said service or procedure performed;
c. a database to store said information inputted by said user;
d. a means for associating a value unit with said service or procedure performed by said user; and
e. a means for determining a compensation rate from value units.

12. The system of claim 11 wherein the user interface is displayed on a touch screen display.

13. The system of claim 11 wherein said application is an iOS application.

14. The system of claim 11 wherein said means for associating a value unit with said service or procedure is a central processing unit.

15. The system of claim 11 wherein the means for determining a compensation rate from value units is a central processing unit.

16. A method to determine an accurate value for the health care procedure or service performed to assist a physician or health care provider in determining appropriate compensation comprising:
a. selecting a patient on an application;
b. inputting information about said patient;
c. inputting a type of service or procedure performed by a user;
d. inputting an amount of time spent by said user on said service or procedure;
e. associating a value unit with said type of service or procedure performed by said user;
f. storing said information about said patient, the type of service or procedure formed by said user, the amount of time spent by said user on said service or procedure, and the associated value unit on a database; and;
g. calculating a compensation rate from value units.

17. The method of claim 16 further comprising comparing value units to a separate performance indicator.

18. The method of claim 16 wherein said information about said patient comprises date of birth and patient name.

19. The method of claim 16 wherein said information about said patient is selected from the group of previous medical history, known complications, familial medical history, and demographic complications.

20. The method of claim 16 wherein said type of service or procedure performed by said user can be inputted by selecting a text description.

21. The method of claim 16 wherein said type of service or procedure performed by said user can be inputted by selecting a code number.

22. The method of claim 21 wherein said code number is selected from the group of ICD codes, RVBS codes, HCPS codes, CPT codes, RVU, NCCI codes, CMRP codes, GCPI codes, billing codes, and insurance codes.

23. The method of claim 16 wherein the value unit is automatically associated with said type of procedure performed.

24. The method of claim 23 wherein the value unit is automatically associated with said type of procedure performed by an iOS application.

25. The method of claim 16 wherein the value unit is a RVU.

26. The method of claim 16 wherein the value unit is calculated from data comprising: RVU, time for procedure, complexity of procedure, provider specialty, legal risk, and rate of reimbursement.
